(19) United States
(12) Patent Application Publication
(10) Pub. No.: US 2019/0160998 A1
(43) Pub. Date: May 30, 2019

(54) HEADLIGHT CONTROL BASED ON MESSAGING AND SENSOR DATA

(71) Applicant: GM Global Technology Operations LLC, Detroit, MI (US)

(72) Inventors: Mohammad Naserian, Windsor (CA); Vivek Vijaya Kumar, Shelby Township, MI (US); Hariharan Krishnan, Troy, MI (US); Donald K. Grimm, Utica, MI (US); Allan K. Lewis, Windsor (CA)

(21) Appl. No.: 15/825,718

(22) Filed: Nov. 29, 2017

(51) Int. Cl. B60Q 1/08; B60Q 1/115; G08G 1/0967; G08G 1/16

(52) U.S. Cl. CPC B60Q 1/085; B60Q 1/115; H04L 67/12; G08G 1/161; H04W 4/046; G08G 1/096791

(57) ABSTRACT

A system and method to control headlights of a vehicle includes receiving a broadcast that indicates a location of a sending device of the broadcast. The method also includes obtaining other information that indicates at least one of a weather condition or an ambient lighting condition, and analyzing the broadcast and the other information to determine whether the headlights should be enabled or whether high beams of the headlights should be enabled. The method further includes generating a signal to control the headlights according to the analysis.

### INTRODUCTION

The subject disclosure relates to headlight control based on messaging and sensor data.

More and more systems in vehicles (e.g., automobiles, trucks, construction equipment) include autonomous functionality. For example, adaptive cruise control systems adjust speed based on traffic. As another example, daytime running light systems automatically turn on headlights when a vehicle is moving. Vehicles are also increasingly obtaining information to make determinations regarding the autonomous functionality. For example, obstacle detection and tracking systems such as radar, lidar, and cameras may provide information for autonomous collision avoidance vehicle systems. Communication (e.g., vehicle-to vehicle (V2V) communication, vehicle-to-infrastructure (V2I)) that is generally referred to as V2X communication also provides information that the vehicle may use to make decisions that affect the control of vehicle systems. While daytime running lights (DRLs) are thought to increase safety, simply having the headlights on for the duration of vehicle operation may be inefficient and may not necessarily be the safest option in all situations. Accordingly, it is desirable to provide headlight control based on messaging and sensor data.

### SUMMARY

In one exemplary embodiment, a method of controlling headlights of a vehicle includes receiving a broadcast that indicates a location of a sending device of the broadcast. The method also includes obtaining other information that indicates at least one of a weather condition or an ambient lighting condition, analyzing the broadcast and the other information to determine whether the headlights should be enabled or whether high beams of the headlights should be enabled, and generating a signal to control the headlights according to the analyzing.

In addition to one or more of the features described herein, the method includes obtaining sensor data that indicates an object located in a field of view of a sensor of the vehicle.

In addition to one or more of the features described herein, the method includes determining whether the headlights should be enabled and whether the high beams of the headlights should be enabled based additionally on the sensor data.

In addition to one or more of the features described herein, the receiving the broadcast includes receiving a vehicle-to-vehicle (V2V) message from the sending device that is another vehicle.

In addition to one or more of the features described herein, the receiving the broadcast from the other vehicle includes receiving information regarding a location, speed, and heading of the other vehicle.

In addition to one or more of the features described herein, the receiving the broadcast includes receiving a vehicle-to-infrastructure (V2I) message from the sending device that is temporary or fixed infrastructure.

In addition to one or more of the features described herein, the receiving the broadcast includes receiving information regarding a road condition or hazard at a location specified by the broadcast.

In addition to one or more of the features described herein, the receiving the broadcast includes receiving a message from the sending device that is carried by a pedestrian or cyclist.

In addition to one or more of the features described herein, the generating the signal includes generating a respective signal for each light emitting diode (LED) of a plurality of LEDs of each of the headlights.

In another exemplary embodiment, a system to control headlights of a vehicle includes a radio access technology (RAT) communication device to receive a broadcast that indicates a location of a sending device of the message. The system also includes a controller to obtain other information that indicates at least one of a weather condition or an ambient lighting condition, obtain the broadcast, perform an analysis of the broadcast and the other information to determine whether the headlights should be enabled, and generate a signal to control the headlights according to the analysis.

In addition to one or more of the features described herein, the system includes a sensor of the vehicle configured to obtain sensor data that indicates an object located in a field of view of the sensor.

In addition to one or more of the features described herein, the controller determines whether the headlights should be enabled based additionally on the sensor data.

In addition to one or more of the features described herein, the broadcast is a vehicle-to-vehicle (V2V) message that includes information regarding a location, speed, and heading of the other vehicle, and the sending device is another vehicle.

In addition to one or more of the features described herein, the broadcast is a vehicle-to-infrastructure (V2I) message that includes information regarding a road condition or hazard at a location specified by the broadcast, and the sending device is temporary or fixed infrastructure.

In addition to one or more of the features described herein, the sending device is carried by a pedestrian or cyclist, and the broadcast includes a location of the sending device carried by the pedestrian or cyclist.

In addition to one or more of the features described herein, the controller generates the signal as a respective signal for each light emitting diode (LED) of a plurality of LEDs of each of the headlights.

In yet another exemplary embodiment, a system to control headlights of a vehicle includes a radio access technology (RAT) communication device configured to receive a broadcast that indicates a location of a sending device of the message. The system also includes a controller to obtain other information that indicates at least one of a weather condition or an ambient lighting condition, obtain the broadcast, perform an analysis of the broadcast and the other information to determine whether high beams of the headlights should be enabled, and generate a signal to control the headlights according to the analysis.

In addition to one or more of the features described herein, the system includes a sensor of the vehicle configured to obtain sensor data that indicates an object located in a field of view of the sensor, wherein the controller determines whether the high beams of the headlights should be enabled based additionally on the sensor data.

In addition to one or more of the features described herein, the broadcast is a vehicle-to-vehicle (V2V) message that includes information regarding a location, speed, and heading of the other vehicle, the broadcast is a vehicle-to-infrastructure (V2I) message that includes information regarding a road condition or hazard at a location specified by the broadcast, and the sending device is temporary or fixed infrastructure, or the broadcast includes a location of the sending device carried by a pedestrian or cyclist.

In addition to one or more of the features described herein, the controller is further configured to generate the signal as a respective signal for each light emitting diode (LED) of a plurality of LEDs of each of the headlights.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows exemplary inputs for headlight control based on messaging and sensor data according to one or more embodiments; and

FIG. 2 is a process flow of a method of controlling the headlights based on messaging and sensor data according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

As previously noted, DRL, which are increasingly available in vehicles as a safety feature, may not always be the most efficient or safest option. For example, the power consumption attributed to DRL being enabled is essentially wasted when the vehicle is travelling on a rural road and encounters no traffic. Other types of light settings that are automatically enabled based on lighting conditions rather than during all vehicle operation, for example, may also have inefficiencies. Yet, disabling the DRL to address this potential inefficiency, for example, is undesirable if a sudden low-light situation is encountered. When the lights are on in low-light conditions, the high beams may increase visibility for the driver but, if there is oncoming traffic, the high beams may have a blinding effect on the approaching drivers. Thus, just as it may be desirable to enable headlights during the day (e.g., DRL) only when they are needed, it may be similarly desirable to enable high beams only when it is safe.

Embodiments of the systems and methods detailed herein relate to headlight control based on messaging and sensor data. Vehicles receive information from sensors and via different forms of communication. V2V messaging may indicate the location and direction of travel of an oncoming vehicle, for example, and may affect the enabling or disabling of the high beams. V2I messaging may indicate an upcoming tunnel, for example, and may result in the DRL being enabled or may indicate an upcoming sharp curve, as another example, and may result in the high beams being enabled in low-light conditions. In additional or alternate embodiments, sensor data may indicate the presence of an object in the line-of-sight of the sensor. This sensor data may augment information when messaging is also available regarding the same object or may substitute information that is not available otherwise.

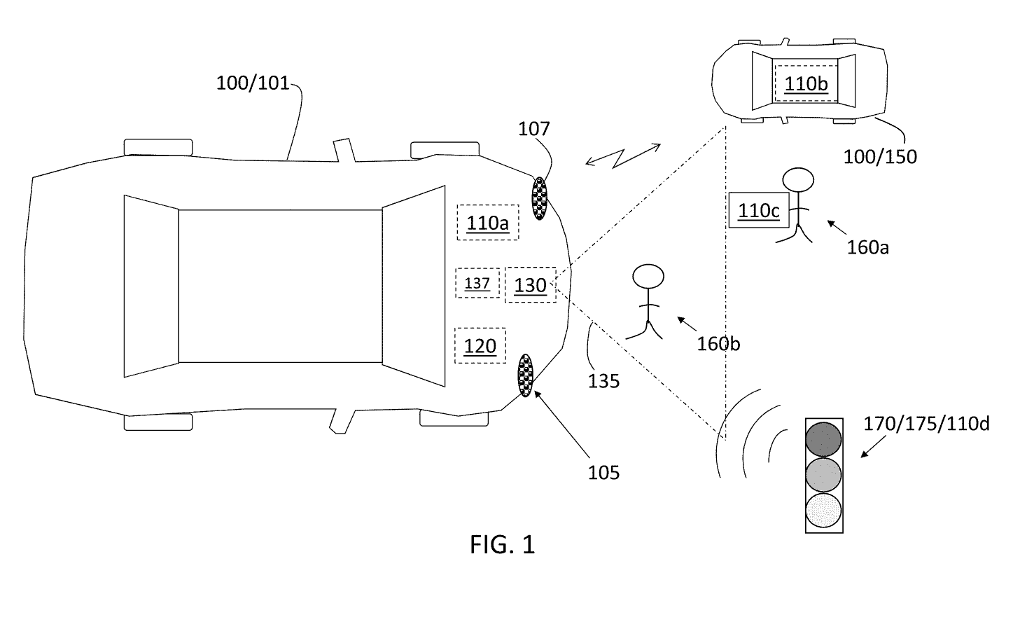

In accordance with an exemplary embodiment, FIG. 1 shows exemplary inputs for headlight 105 control based on messaging and sensor 130 data. The exemplary vehicle 100 shown in FIG. 1 is an automobile 101. The automobile has headlights 105 that are controlled by a controller 120. In the exemplary embodiment shown in FIG. 1, each of the headlights 105 is comprised of several light emitting diodes (LEDs) 107. The controller 120 may be the same as or may be coupled to the electronic control unit (ECU) that controls other vehicle systems (e.g., collision avoidance system, adaptive cruise control). A communication device 110a in the vehicle 100 may be part of the controller 120 or the ECU. The communication device 110a represents one or more known radio access technologies (RATs) such as those that provide access to WiFi, cellular, or Bluetooth, for example. The communication device 110a performs the V2X communication that facilitates control of the headlights 105 according to one or more embodiments.

The vehicle 100 may also include one or more known sensors 130 (e.g., radar, lidar, camera) and a source 137 of other information. Each sensor 130 has a particular field of view (FOV) 135, and two or more sensors 130 may have overlapping FOV 135. The source 137 of other information may be the ECU or vehicle systems that determine ambient lighting conditions and weather conditions. For example, the source 137 of other information may indicate whether it is raining. This source 137 may be coupled to a rain sensor of the windshield or may obtain the windshield wiper stalk setting.

The controller 120 includes processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

Another vehicle 100 in FIG. 1 is an approaching automobile 150 from the perspective of the automobile 101. The approaching automobile 150 includes a communication device 110b that may perform V2V communication with the automobile 101. FIG. 1 also indicates two pedestrians 160a, 160b in front of the automobile 101. One of the pedestrians 160a shown in FIG. 1 is carrying a communication device 110c. This communication device 110c may be used to perform communication with the automobile 101. The other pedestrian 160b may be detected by one of the sensors 130 of the automobile 101. The traffic light 175 shown in FIG. 1 represents infrastructure 170 that may perform V2I communication with the automobile 101 based on a communication device 110d. For example, the traffic light 175 may broadcast information regarding its location and current status (e.g., green light) as well as the time remaining until a change in status (e.g., 5 seconds to yellow light).

The V2X communication among the various communication devices 110a, 110b, 110c 110d (generally referred to as 110) may be via a known dedicated short range communication (DSRC) standard. The DSRC standard is similar to WiFi but operates on a dedicated frequency band and is optimized for low latency and mobility scenarios. Generally, any known messaging standards and structures may be used for the communication. For example, V2V communication may provide the latitude, longitude, elevation, speed, yaw, and heading of the vehicle 100 that is sending the message such that other vehicles 100 that receive the message know its location. A V2I message may be broadcast by temporary infrastructure 170 that is set up to indicate the location of a temporary condition such as a work zone or an accident or may be broadcast by fixed infrastructure 170 that indicates the location of an upcoming sharp curve, for example. Other V2X messages may include a vulnerable road user (VRU) message indicating the location, speed, and heading of a pedestrian or cyclist, for example. All of these types of messages may be broadcast periodically.

The controller 120 uses information in V2X messages or information from one or more sensors 130 to control the headlights 105. For example, the controller 120 may disable the DRL until a V2V message is received that indicates that another vehicle 100 is approaching or a V2I message is received that indicates that a construction zone will be encountered. In low-light conditions, when the headlights 105 are enabled, the controller 120 may enable the high beams to illuminate the pedestrian 160a based on a V2X message from the device 110c that indicates the location of the pedestrian 160a as being 100 feet away, for example.

As another example, the presence of the pedestrian 160b may be detected based on a sensor 130 such that the high beams are enabled by the controller 120. A V2V message from the approaching automobile 150 indicating its location may cause the controller 120 to disable the high beams to prevent glare for the driver of the automobile 150. A V2I message indicating an approaching sharp curve, in the absence of an indication of the approaching automobile 150, may also cause the controller 120 to enable the high beams. Thus, the controller 120 may operate according to rules that may be overridden by other, higher priority rules. For example, an approaching hazard may be associated with a rule that the high beams should be enabled, but this rule may be overridden when an approaching automobile 150 is detected.

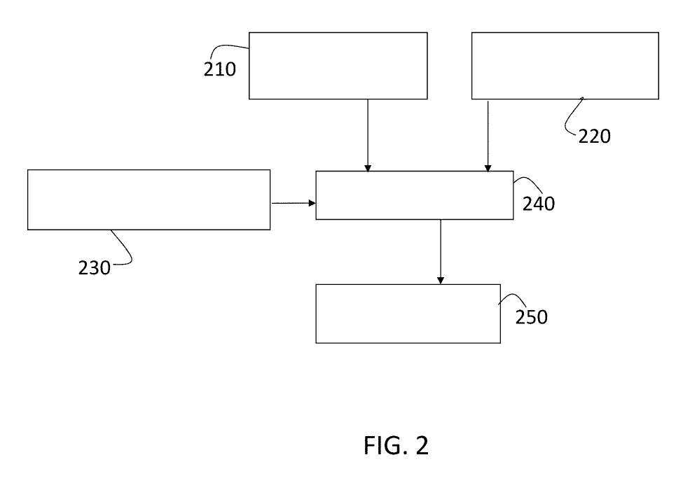

FIG. 2 is a process flow of a method of controlling the headlights 105 based on messaging and sensor 130 data according to one or more embodiments. The processes shown in FIG. 2 may be performed by the controller 120. At block 210, receiving messages refers to receiving V2X messages. V2X messages include V2V messages broadcast by other vehicles 100 such as the approaching automobile 150 shown in FIG. 1. V2X messages also include V2I messages broadcast by temporary infrastructure 170 (e.g., a communication device 110 set up at an accident site or at an icy patch in the road) or other infrastructure 170 (e.g., traffic light 175). V2X messages also include broadcasts from pedestrians or cyclists carrying communication devices 110.

At block 220, obtaining sensor 130 data refers to the controller 120 obtaining information from a radar, lidar, camera, or other sensor that detects objects in its FOV. Obtaining other information includes obtaining weather information and ambient lighting information, for example, from a source 137 that may be coupled to vehicle systems, such as the ECU. Analyzing information, at block 240, refers to the controller 120 using the messages received at block 210, the sensor data obtained at block 220, the other information obtained at block 230, or a combination of the three to determine whether the headlights 105 should be enabled and, additionally, whether the high beams should be enabled.

Controlling the headlights, at block 250, includes the controller 120 sending a signal to the headlights 105 directly or to the ECU or other interface that controls the headlights 105. When the headlights 105 have two or more LEDs 107, as in the exemplary automobile 101 shown in FIG. 1, the controller 120 may send a specific signal to control each LED 107 separately. For example, when a curve is indicated on the left side of the automobile 101 by a V2I message, LEDs 107 on the left may be illuminated to a higher intensity than other LEDs 107 of the headlights 105. As another example, when a pedestrian 160b is detected by a sensor 130 or a pedestrian 160a has a device 110c that broadcasts a message indicating its location, the controller 120 may control the LEDs 107 that correspond to the location of the pedestrian 160a, 160b to have higher intensity light output than other LEDs 107 of the headlights 105.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of controlling headlights of a vehicle, the method comprising:
receiving a broadcast, at a controller of the vehicle, that indicates a location of a sending device of the broadcast;
obtaining, at the controller, other information that indicates at least one of a weather condition or an ambient lighting condition;
analyzing, at the controller, the broadcast and the other information to determine whether the headlights should be enabled or whether high beams of the headlights should be enabled; and
generating a signal, at the controller, to control the headlights according to the analyzing.

2. The method according to claim 1, further comprising obtaining sensor data that indicates an object located in a field of view of a sensor of the vehicle.

3. The method according to claim 2, further comprising determining whether the headlights should be enabled and whether the high beams of the headlights should be enabled based additionally on the sensor data.

4. The method according to claim 1, wherein the receiving the broadcast includes receiving a vehicle-to-vehicle (V2V) message from the sending device that is another vehicle.

5. The method according to claim 4, wherein the receiving the broadcast from the other vehicle includes receiving information regarding a location, speed, and heading of the other vehicle.

6. The method according to claim 1, wherein the receiving the broadcast includes receiving a vehicle-to-infrastructure (V2I) message from the sending device that is temporary or fixed infrastructure.

7. The method according to claim 6, wherein the receiving the broadcast includes receiving information regarding a road condition or hazard at a location specified by the broadcast.

8. The method according to claim 1, wherein the receiving the broadcast includes receiving a message from the sending device that is carried by a pedestrian or cyclist.

9. The method according to claim 1, wherein the generating the signal includes generating a respective signal for each light emitting diode (LED) of a plurality of LEDs of each of the headlights.

10. A system to control headlights of a vehicle, the system comprising:
a radio access technology (RAT) communication device configured to receive a broadcast that indicates a location of a sending device of the message; and
a controller configured to obtain other information that indicates at least one of a weather condition or an ambient lighting condition, obtain the broadcast, perform an analysis of the broadcast and the other information to determine whether the headlights should be enabled, and generate a signal to control the headlights according to the analysis.

11. The system according to claim 10, further comprising a sensor of the vehicle configured to obtain sensor data that indicates an object located in a field of view of the sensor.

12. The system according to claim 11, wherein the controller the controller is further configured to determine whether the headlights should be enabled based additionally on the sensor data.

13. The system according to claim 10, wherein the broadcast is a vehicle-to-vehicle (V2V) message that includes information regarding a location, speed, and heading of the other vehicle, and the sending device is another vehicle.

14. The system according to claim 10, wherein the broadcast is a vehicle-to-infrastructure (V2I) message that includes information regarding a road condition or hazard at a location specified by the broadcast, and the sending device is temporary or fixed infrastructure.

15. The system according to claim 10, wherein the sending device is carried by a pedestrian or cyclist, and the broadcast includes a location of the sending device carried by the pedestrian or cyclist.

16. The system according to claim 10, wherein the controller is further configured to generate the signal as a respective signal for each light emitting diode (LED) of a plurality of LEDs of each of the headlights.

17. A system to control headlights of a vehicle, the system comprising:
a radio access technology (RAT) communication device configured to receive a broadcast that indicates a location of a sending device of the message; and
a controller configured to obtain other information that indicates at least one of a weather condition or an ambient lighting condition, obtain the broadcast, perform an analysis of the broadcast and the other information to determine whether high beams of the headlights should be enabled, and generate a signal to control the headlights according to the analysis.

18. The system according to claim 17, further comprising a sensor of the vehicle configured to obtain sensor data that indicates an object located in a field of view of the sensor, wherein the controller determines whether the high beams of the headlights should be enabled based additionally on the sensor data.

19. The system according to claim 17, wherein the broadcast is a vehicle-to-vehicle (V2V) message that includes information regarding a location, speed, and heading of the other vehicle, the broadcast is a vehicle-to-infrastructure (V2I) message that includes information regarding a road condition or hazard at a location specified by the broadcast, and the sending device is temporary or fixed infrastructure, or the broadcast includes a location of the sending device carried by a pedestrian or cyclist.

20. The system according to claim 17, wherein the controller is further configured to generate the signal as a respective signal for each light emitting diode (LED) of a plurality of LEDs of each of the headlights.
